(19) United States
(12) Patent Application Publication
(10) Pub. No.: US 2009/0164883 A1
(43) Pub. Date: Jun. 25, 2009

(54) Multi-Source Web Clips

(75) Inventors: Kevin Decker, San Jose, CA (US); John Sullivan, Pacific Grove, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/960,389

(22) Filed: Dec. 19, 2007

(51) Int. Cl. G06F 17/00

(52) U.S. Cl. 715/234

(57) ABSTRACT

Methods, computer program products, and systems are described to assist a user in identifying a number of potential areas of interest (sometimes referred to as clippings or web clips) and presenting the areas in a uniform display environment. In some implementations, the user clippings are presented to the user in a clipview according to user preferences.

### TECHNICAL FIELD

The subject matter of this patent application relates to information presentation.

### BACKGROUND

Traditional computer systems allow a user to clip items of interest, such as blocks of text, from one or more documents into a clipboard. The user may individually clip each item of interest from each document and then paste the contents of the clipboard into a target document. If the user becomes aware that the items of interest have been modified in the one or more documents, the user may again individually clip the now-modified items of interest from the one or more documents, and re-paste each now-modified clipboard portion into the target document.

Common browsers allow a user to select a web page, and to further select an area of interest in the web page for display by scrolling until the area of interest displays in the browser's display window. If the user desires to have the browser display the most current content in the selected area of interest in the web page, the user may manually request a refresh of the web page. After closing the browser, if the user again desires to view the area of interest, the user may launch the browser and repeat the process of selecting the area of interest. Furthermore, if the user desires to select areas of interests from one or more web pages, the user must launch a separate browser for each web page. If the user desires to have the browsers display the most current content in the selected areas of interest in the one or more web pages, the user may manually request a refresh of each web page.

### SUMMARY

Methods, computer program products, and systems are described to assist a user in identifying a number of potential areas of interest (sometimes referred to as clippings or web clips) and presenting the areas in a uniform display environment. In some implementations, the user clippings are presented to the user in a clipview according to user preferences.

In one aspect, a method is provided that includes receiving input to select a plurality of content sources and one or more portions of each of the plurality of content sources corresponding to areas of interest; identifying a signature associated with each of the one or more portions; storing the signatures; and presenting clippings corresponding to the signatures in a clipview.

One or more implementations can optionally include one or more of the following features. The method can include presenting the clippings at a same time. The method can also include presenting the clippings sequentially in time. The method can further include presenting the clippings according to user preferences. The method can further include presenting the clippings in a webview, wherein the webview is one form of a clipview. The method can further include receiving user input to toggle among a plurality of views.

In another aspect, a method is provided that includes providing a user interface for presentation on a display device, the user interface including a display area for displaying content; identifying one or more portions of each of a plurality of content sources displayed in the display area, the portions corresponding to areas of interest; identifying a signature associated with each of the one or more portions; storing the signatures; and presenting clippings corresponding to the signatures in a clipview in the user interface.

Aspects of the invention can include none, one or more of the following. A clipview provides a single interface for the user to view clippings from a plurality of content sources. A user may view refreshed content from a plurality of content sources without navigating through multiple interfaces. In addition, the user does not have to manually request a refresh of each interface in order to view updated content from each of the plurality of content sources.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example clipping application and components thereof.

FIG. 2A is a screenshot showing example content of a content source.

FIG. 2B is a screenshot showing example content of another content source.

FIG. 3 is a flow chart showing an example process for presenting clippings from a plurality of content sources.

FIG. 4 is a screenshot showing an example user interface with widgets and a clipview.

FIG. 5A is a screenshot showing an example clipping from the content source of FIG. 2A.

FIG. 5B is a screenshot showing an example clipping from the content source of FIG. 2B.

FIG. 6 is a flow chart showing an example process for sequentially presenting clippings from a plurality of content sources.

FIG. 7 is a flow chart showing an example process for effectuating a toggle effect on clippings from a plurality of content sources.

FIG. 8 is a block diagram showing a system for clipping content from a plurality of content sources.

### DETAILED DESCRIPTION

### Clipping Application Components

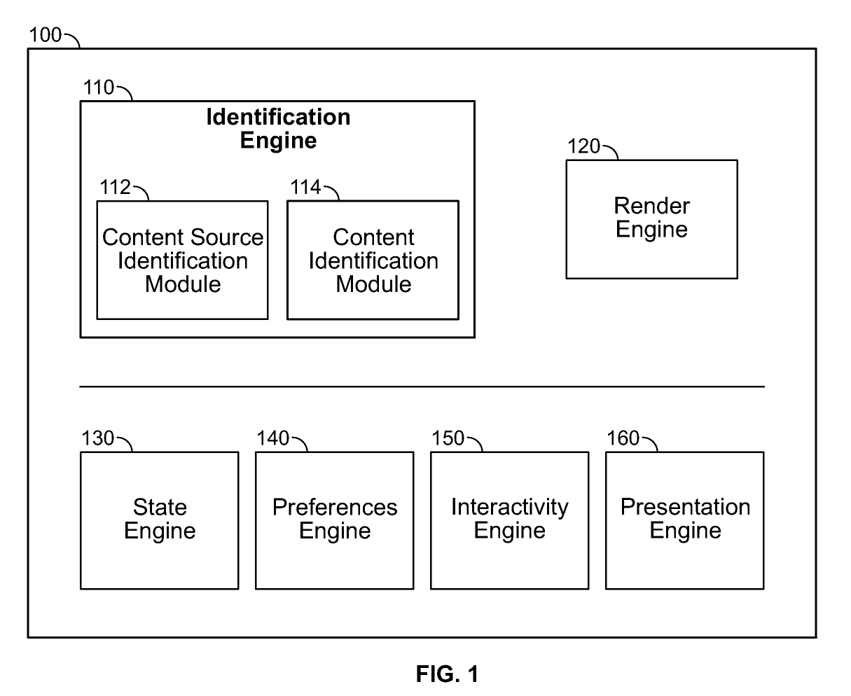

Referring to FIG. 1, components of a clipping application 100 are shown. Clipping application 100 provides functionality for clipping content from a plurality of content sources and presenting the clipped content or clippings to a user. Clipping application 100 generally includes an identification engine 110 for identifying a plurality of content sources and content to be clipped, a render engine 120 for rendering content, a state engine 130 for enabling a refresh of the clipped content, a preferences engine 140 for setting preferences associated with, for example, the display and configuration of the clipped content, an interactivity engine 150 for processing interactions between a user and the plurality of content sources and the clipped content, and a presentation engine 160 for presenting the clipped content from the plurality of content sources to a user. Engines 110-160 can be communicatively coupled to one or more of each other. Though the engines identified above are described as being separate or distinct, one or more of the engines may be combined in a single process or routine. The functional description provided herein including separation of responsibility for distinct functions is by way of example. Other groupings or other divisions of functional responsibilities can be made as necessary or in accordance with design preferences.

Clipping application 100 can be a lightweight process that uses, for example, objects defined as part of a development environment such as the Cocoa Application Framework (as referred to as the Application Kit or AppKit, described for example at Mac OS X Leopard Release Notes Cocoa Application Framework, available from Apple Inc.). Clippings produced by clipping application 100 can be implemented in some instantiations as simplified browser screens that omit conventional interface features such as menu bars, window frame, and the like.

### Identification Engine

Identification engine 110 may be used to initially identify content to be clipped from a plurality of content sources. A content source can be, without limitation, a file containing images, text, graphics, forms, music, and videos. A content source can also include a document having any of a variety of formats, files, pages and media, an application, a presentation device or inputs from hardware devices (e.g., digital camera, video camera, web cam, scanner, microphone, etc.).

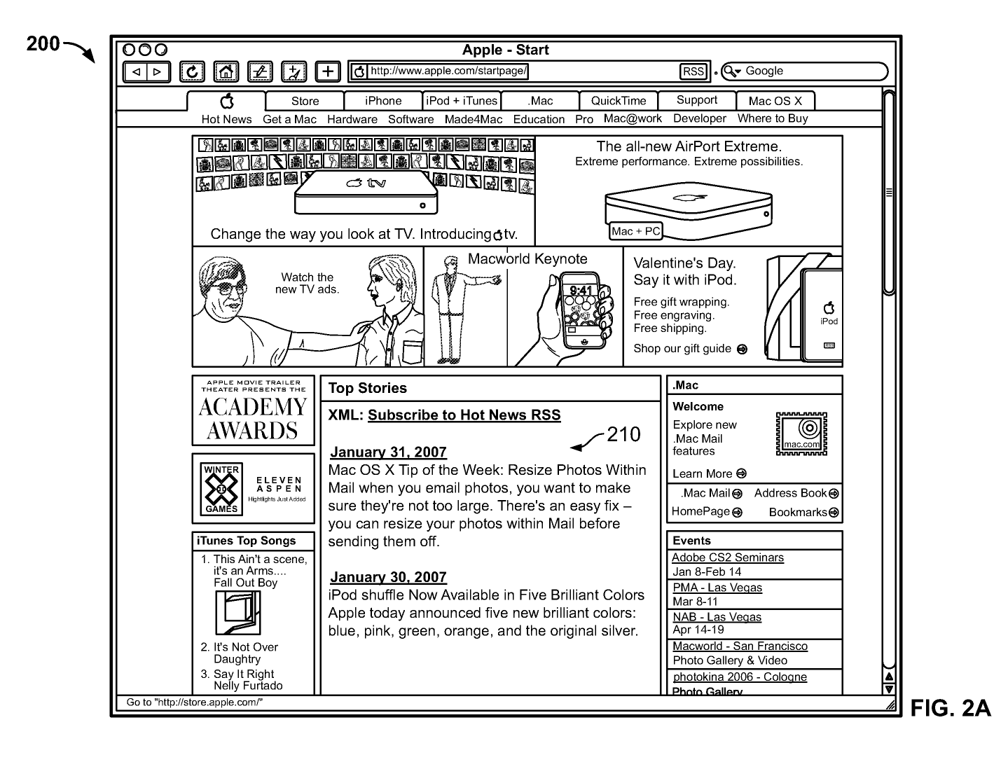

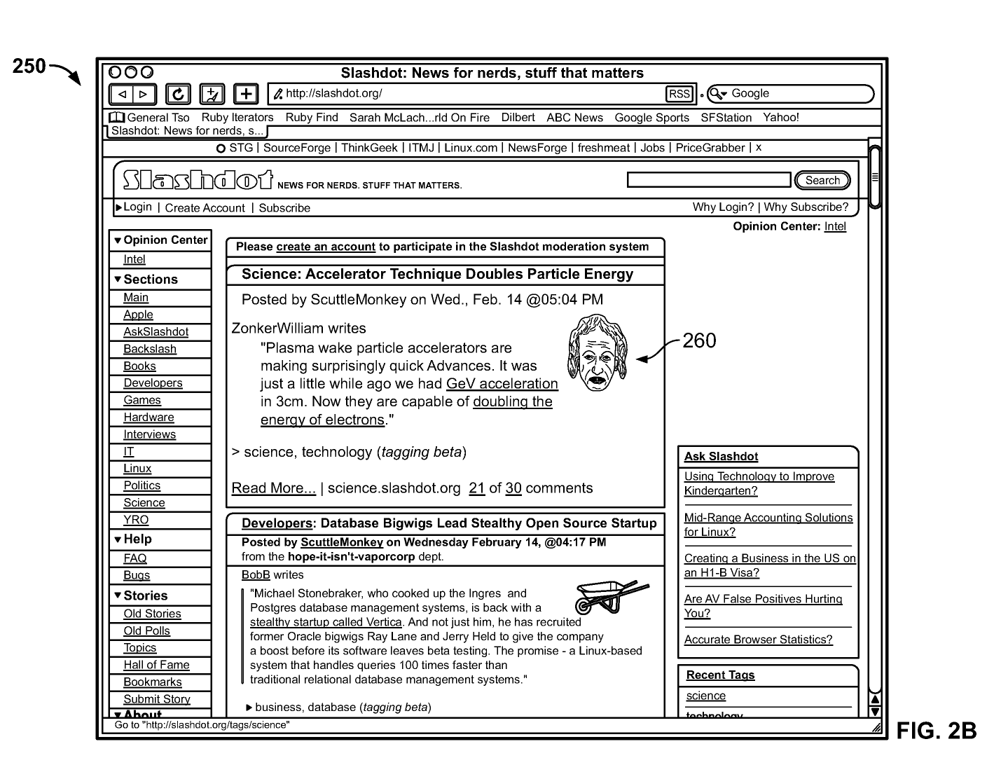

FIG. 2A is a screenshot showing example content 210 of a content source 200. In particular, FIG. 2A shows a browser displaying a web page. FIG. 2B is a screenshot showing example content 260 of another content source 250. In particular, FIG. 2B shows a browser displaying another web page. As an example, the identification engine 110 may be used to identify content 210 from content source 200 and content 260 from content source 250. In some implementations, identification engine 110 may be used to identify content from more than two content sources.

Identification engine 110 can identify a plurality of content sources, as will be described in greater detail below with respect to content source identification module 112. In some implementations, upon activation, identification engine 110 can automatically identify a default plurality of content sources. Alternatively, the process of identifying the plurality of content sources may include receiving content source selections from the user, and manually selecting and confirming each of the plurality of content sources.

In some implementations, upon activation, the identification engine 110 can automatically identify and highlight default content in each of the plurality of content sources. Alternatively, the process of identifying content from each of the plurality of content sources to be clipped may include receiving a clipping request from the user, and manual input selecting and confirming content to be clipped.

In clipping content from each of the plurality of content sources, the identification engine 110 may obtain information about each of the plurality of content sources (e.g., identifier, origin, etc.) from which the content was clipped as well as configuration information about the presentation tool (e.g., the browser) used in the clipping operation. Such configuration information may be required to identify an area of interest within the each of the plurality of content sources. An area of interest can represent a contiguous area of a content source, such as a frame or the like, or can be an accumulation of two or more non-contiguous or unrelated pieces of content from a single or multiple sources.

As an example, when a web page (e.g., one form of a content source) is accessed from a browser, the configuration of the browser (e.g. size of the browser window) can affect how content from the web page is actually displayed (e.g., page flow, line wrap, etc.), and therefore which content the user desires to have clipped.

The identification engine 110 also can function to access a previously selected area of interest during a refresh of the clipped content. Identifying content or accessing a previously identified area of interest from the plurality of content sources can include numerous operations that may be performed, in whole or in part, by the identification engine 110, or may be performed by another engine such as one of engines 110-160. For example, the identification engine 110 may identify a plurality of content sources, enable a view to be presented, such as one or more windows, that displays the plurality of content sources (e.g., sequentially or simultaneously, etc.), enable the view to be shaped (or reshaped), sized (or resized) and positioned (or repositioned), and enable the plurality of content sources to be repositioned within the view to select or navigate through the plurality of content sources and to select or navigate to an area of interest in which the desired content from each of the plurality of content sources to be clipped resides.

Enabling a view to be presented may include, for example, identifying a default (or user specified) size, shape and screen position for a new view, accessing parameters defining a frame for the new view including position, shape, form, size, etc., accessing parameters identifying the types of controls for the new view, as well as display information for those controls that are to be displayed, with display information including, for example, location, color, and font, and presenting the new view.

Further, as will be discussed in more detail below, the identification engine 110 may be initialized in various ways, including, for example, by receiving a user request to select a plurality of content sources, by receiving a user request to clip content from each of the plurality of content sources, by receiving a user's acceptance of a prompt to create a clipping, or automatically.

### Content Source Identification Module

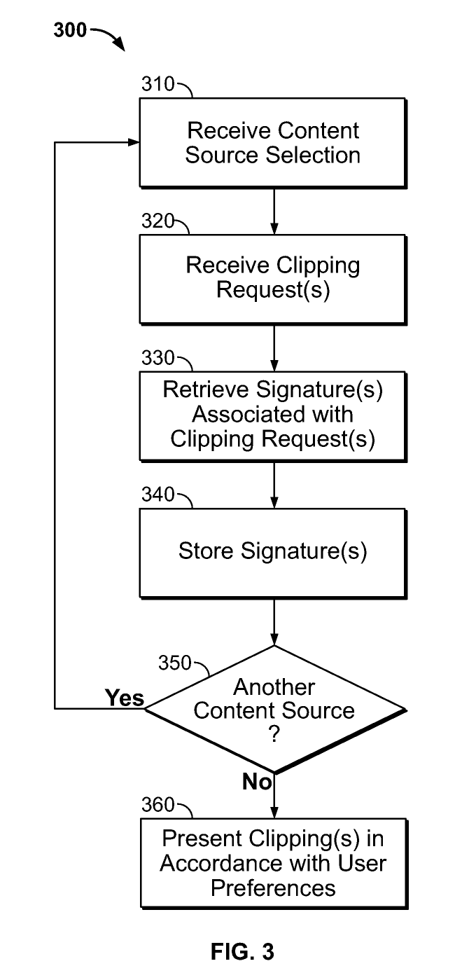

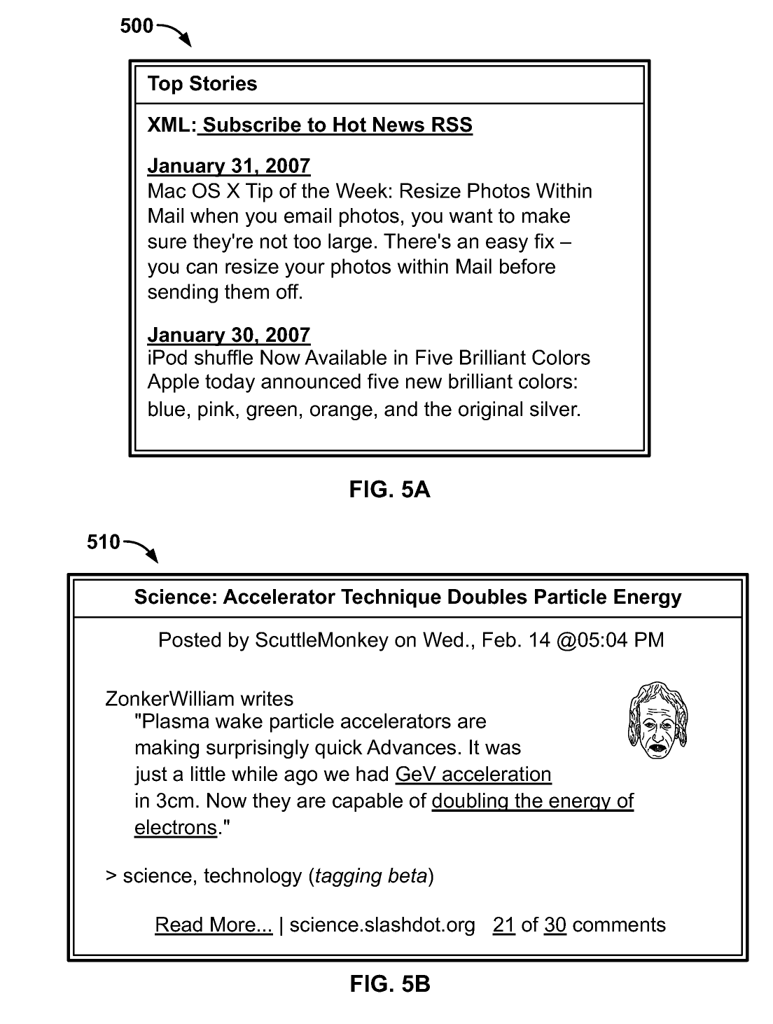

Content source identification module 112 is operable to receive user input to identify a plurality of content sources. The content source identification module 112 can include a detection mechanism to detect user input (e.g., selection of a browser window), for enabling content source identification. In some implementations, the content source identification module is responsive to receipt of user input selecting an edge, frame, or icon of a content source and triggers the selection of the content source. Content source identification will be described in greater detail below with reference to FIGS. 3 and 5.

### Content Identification Module

Content identification module 114 is operable to identify content to be clipped from each of the plurality of content sources. Further description regarding identifying content to be clipped from a content source and techniques thereof can be found in a related U.S. patent application Ser. No. 11/760,658 titled “Creating Web Clips”, and U.S. patent application Ser. No. 11/760,650 titled “Web Clip Using Anchoring”.

### Render Engine

Render engine 120 may be used to render content that is to be presented to a user in a clipping or during a clip setup process. Render engine 120 may be placed in whole or in part of the identification engine 110. Alternatively, the render engine 120 may be part of another engine, such as, for example, presentation engine 160 which is discussed below, and a separate stand-alone application that renders content.

Implementations may render a plurality of entire content sources or only a portion of the plurality of the content sources, such as, for example, the areas of interest. Further description regarding rendering content and techniques thereof can be found in a related U.S. patent application Ser. No. 11/760,658 titled “Creating Web Clips”, and U.S. patent application Ser. No. 11/760,650 titled “Web Clip Using Anchoring”.

### State Engine

State engine 130 may be used to store information (e.g., metadata) needed to refresh clipped content and implement a refresh strategy. Such information is referred to as state information and may include, for example, a selection definition including an identifier of each of the plurality of content sources as well as additional navigation information that may be needed to access each of the plurality of content sources, and one or more identifiers associated with the selected areas of interest within the plurality of content sources. The additional navigation information may include, for example, login information and passwords (e.g., to allow for authentication of a user or subscription verification), permissions (e.g., permissions required of users to access or view content that is to be included in a given clipping), and may include a script for sequencing such information. State engine 130 also may be used to set refresh timers based on refresh rate preferences, to query a user for refresh preferences, to process refresh updates pushed or required by the source sites or otherwise control refresh operations as discussed below (e.g., for live or automatic updates).

In some implementations, the state engine 130 may store location information that is, for example, physical or logical. Physical location information can include, for example, an (x, y) offset of an area of interest within a content source, including timing information (e.g., number of frames from a source). Logical location information can include, for example, a URL of a web page, HTML tags in a web page that may identify a table or other information, or a cell number in a spreadsheet. State information may include information identifying the type of content being clipped, and the format of the content being clipped.

### Preferences Engine

Preferences engine 140 may be used to query a user for preferences during the process of creating a clipping. Preferences engine 140 also may be used to set preferences to default values, to modify preferences that have already been set, and to present the preference selections to a user. Preferences may relate to, for example, a refresh rate, an option of muting sound from the clipping, a volume setting for a clipping, a setting indicating whether a clipping will be interactive, a naming preference to allow for the renaming of a current clipping, a redefinition setting that allows the user to adjust (e.g., change) the area of interest (e.g., reinitialize the focus engine to select a new area of interest to be presented in a clip view), and function (e.g. filter) settings. Preferences also may provide other options, such as, for example, listing a history of content sources that have been clipped, a history of changes to current clippings (e.g., the changes that have been made over time to specific clippings thus allowing a user to select one for the current clipping) and view preferences. View preferences define characteristics (e.g., the size, shape, controls, control placement, etc. of the viewer used to display the content) for the display of the portions of content (e.g., by the presentation engine).

Preferences engine 140 may also be used to query a user for preferences during the process of presenting clippings from the plurality of content sources. View preferences can include presenting clipped content from a plurality of content sources according to user preferences. For example, user preferences can include presenting clipped content from a plurality of content sources at a same time and presenting clipped content from a plurality of content sources sequentially in time, as will be described in greater detail below with respect to presentation engine 160. In some implementations, a user can provide input (e.g., perform mouse-clicks) to switch among presentations of clipped content from a plurality of content sources, as will be described in greater detail below with respect to interactivity engine 150. Other user preferences are possible.

Some or all of the preferences can include default settings or be configurable by a user.

### Interactivity Engine

Interactivity engine 150 may process interactions between a user and clipped content by, for example, storing information describing the various types of interactive content being presented in a clipping. Interactivity engine 150 may use such stored information to determine what action is desired in response to a user's interaction with clipped content, and to perform the desired action. For example, interactivity engine 150 may (1) receive an indication that a user has clicked on a hyperlink displayed in clipped content, (2) determine that a new web page should be accessed, and (3) initiate and facilitate a request and display of a new requested page. As another example, interactivity engine 150 may (1) receive an indication that a user has entered data in a clipped form, (2) determine that the data should be displayed in the clipped form and submitted to a central database, (3) determine further that the next page of the form should be presented to the user in the clipping, and (4) initiate and facilitate the desired display, submission, and presentation. As another example, interactivity engine 150 may (1) receive an indication that a user has indicated a desire to interact with a presented document, and (2) launch an associated application or portion of an application to allow for a full or partial interaction with the document.

Interactivity engine 150 may also process interactions between a user and a plurality of content sources by, for example, receiving an indication that a user would like the clippings from the plurality of content sources to be presented according to the user's preferences, e.g., the view preferences of preference engine 140.

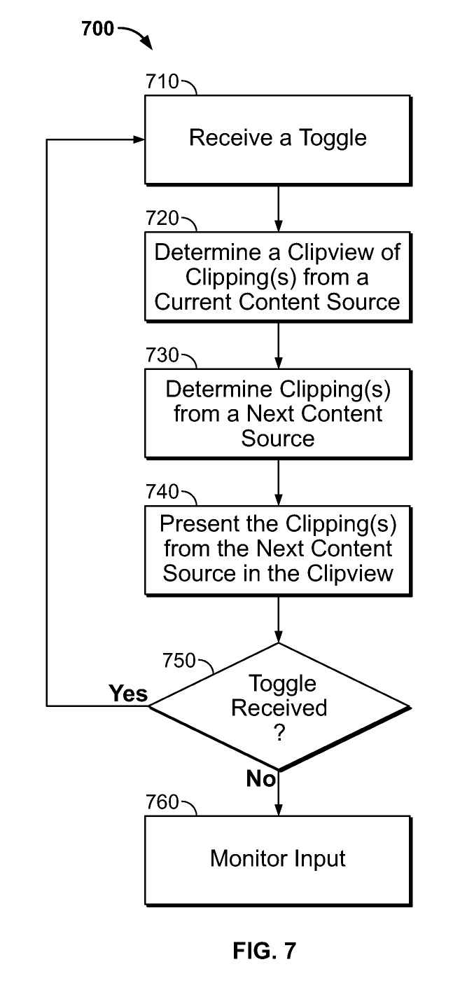

For example, FIG. 7 is a flow chart showing an example process for effectuating a toggle effect on a clipview (clipviews are described in further detail below with respect to FIG. 1). Process 700 may be performed by interactivity engine 150. Process 700 includes receiving a toggle (710), determining a clipview of clipping from a current content source (720), and determining a clipping from a next content source (730). Steps 710, 720, and 730 may be performed in the order listed, in parallel (e.g., by the same or a different process, substantially or otherwise non-serially), or in reverse order. The order in which the operations are performed may depend, at least in part, on what entity performs the method. For example, a computer system may receive a user's toggle (e.g., mouse-click while the mouse cursor is hovering upon a current clipview), determine the current clipview of a current clipping, and then determine a next clipview. As another example, after a user toggles the clipview, interactivity engine 150 may simultaneously determine a current clipview of a current clipping and determine a next clipping. In other implementations, steps 710, 720, and 730 may be performed by different entities rather than by the same entity.

Process 700 includes presenting the clipping from the next content source in the clipview (740). If another toggle is received (“Yes” branch of step 750), a clipping from a next content source can be presented to a user in the clipview, for example, by determining the a clipping from a next content source and presenting the clipping in the clipview (e.g., by the interactivity engine 150). If no toggle is received (“No” branch of step 750), interactivity engine 150 continues to monitor for input (760). Other interactions are possible.

### Presentation engine

Presentation engine 160 may present clipped content to a user by, for example, creating and displaying a user interface on a computer monitor, using render engine 120 to render the clipped content, and presenting the rendered content in a user interface. Presentation engine 160 may include an interface to a variety of different presentation devices for presenting corresponding clipped content. For example, (1) clipped web pages, documents, and images may be presented using a display (e.g., a computer monitor or other display device), (2) clipped sound recordings may be presented using a speaker, and a computer monitor may also provide a user interface to the sound recording, and (3) clipped video or web pages having both visual information and sound may be presented using both a display and a speaker. Presentation engine 160 may include other components, such as, for example, an animation engine (not shown) for use in creating and displaying a user interface with various visual effects such as three-dimensional rotation.

In various implementations, the user interface that the presentation engine 160 creates and displays is referred to as a clipview. Further description regarding clipviews can be found in a related U.S. patent application Ser. No. 11/760,658 titled “Creating Web Clips”, and U.S. patent application Ser. No. 11/760,650 titled “Web Clip Using Anchoring”.

Presentation engine 160 may present clipped content from a plurality of content sources to a user. In some implementations, presentation engine may present clipped content from a plurality of content sources at a same time. For example, clipped content from a plurality of content sources can be tiled in a view portion of a clipview. Alternatively, the clipped content from a plurality of content sources can be cascaded in windows in a view portion of a clipview. In some implementations, controls are available in the border or frame of a clipview to navigate among the clipped content (e.g., using interactivity engine 150).

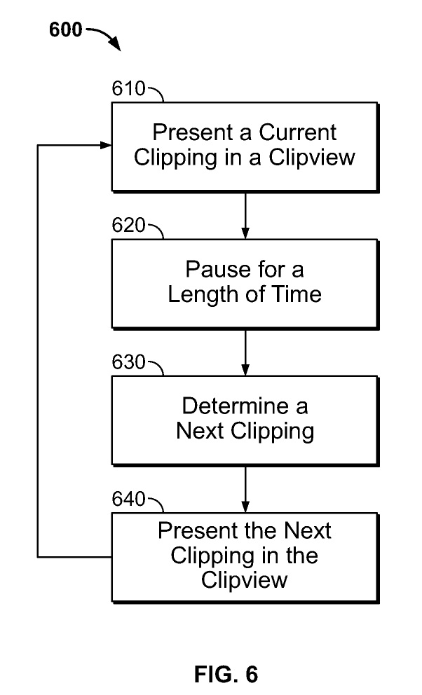

Presentation engine 160 may also present clipped content from a plurality of content sources sequentially in time. For example, FIG. 6 is a flow chart showing an example process for sequentially displaying clippings from a plurality of content sources. Process 600 may be performed by the presentation engine 160. Presentation engine 160 may present a current clipping in a clipview (610). The presentation engine 160 may then pause for a length of time (620), e.g., five minutes, before determining a next clipping (630) and presenting the next clipping in the clipview (640).

In another implementation, presentation engine 160 may switch among presentations of clipped content from the plurality of content sources by, for example, using the process described previously with respect to FIG. 7. Other implementations of presenting the clippings from a plurality of content sources according to additional user preferences are possible.

### Clipping Process

FIG. 3 is a flow chart showing an example process for presenting clippings from a plurality of content sources. Process 300 may be performed, at least in part, by, for example, clipping application 100 running on a computer system.

Process 300 includes receiving a content source selection (310) and receiving a request to clip content (320). Steps 310 and 320 may be performed in the order listed, in parallel (e.g., by the same or a different process, substantially or otherwise non-serially), or in reverse order. The order in which the operations are performed may depend, at least in part, on what entity performs the method. For example, a computer system may receive a user's selection of a content source (310), and the computer system may then receive the user's request to launch clipping application 100 to make a clipping of the content source (320). As another example, after a user selects a content source and then launches clipping application 100, clipping application 100 may simultaneously receive the user's selection of a content source (310) and the user's request for a clipping of that content source (320). As yet another example, a user may launch clipping application 100 and then select a content source from within clipping application 100, in which case clipping application 100 first receives the user's request for a clipping (for example, a clipview) (320), and clipping application 100 then receives the user's selection of the content source(s) to be clipped (310). In other implementations, steps 310 and 320 may be performed by different entities rather than by the same entity.

Process 300 includes retrieving a signature associated with the clipping request (330) and storing the signature of the clipped content (340). Further description regarding retrieving and storing signatures and techniques thereof can be found in a related U.S. patent application Ser. No. 11/760,650 titled “Web Clip Using Anchoring”.

As additional content source selections are received (“Yes” branch of step 350), content sources can be continued to be identified by the user (e.g., by the identification engine 110). If no content source selection is received (“No” branch of step 350), the clippings can be presented to a user by, for example, creating and displaying a user interface on a computer monitor, rendering the selected content from the plurality of content sources, and presenting the rendered content in a user interface in accordance with user preferences (e.g., by the presentation engine 160) (360).

In some implementations, the user can select whether clippings are refreshable clippings or static clippings by choosing a refresh strategy. Refresh strategies can include making the clipping refreshable or static. Other refresh strategies are possible. For example, clippings can be refreshed when the clipping is presented, but only if the content has not been refreshed within a particular time period. In some implementations, a refresh strategy can specify that refreshable clippings will be refreshed at a particular interval of time, whether or not the clipping is currently being presented. Alternatively, a clipping can be refreshed by receiving user input (e.g., refresh on demand). Further description regarding the refresh properties and techniques thereof can be found in a related U.S. patent application Ser. No. 11/145,561 titled “Presenting Clips of Content”, U.S. patent application Ser. No. 11/145,560 titled “Webview Applications”.

A system, processes, applications, engines, methods and the like have been described above for clipping content from a plurality of content sources and presenting the clippings in an output device (e.g., a display). Clippings as described above can be derived from a plurality of content sources, including those provided from the web (i.e., producing a webview), a datastore (e.g., producing a docview) or other information sources.

Clippings as well can be used in conjunction with one or more applications. The clipping application can be a stand alone application, work with or be embedded in one or more individual applications, or be part of or accessed by an operating system. The clipping application can be a tool called by an application, a user, automatically or otherwise to create, modify and present clippings.

The clipping application described herein can be used to present clipped content in a plurality of display environments. Examples of display environments include a desktop environment, a dashboard environment, an on screen display environment or other display environment.

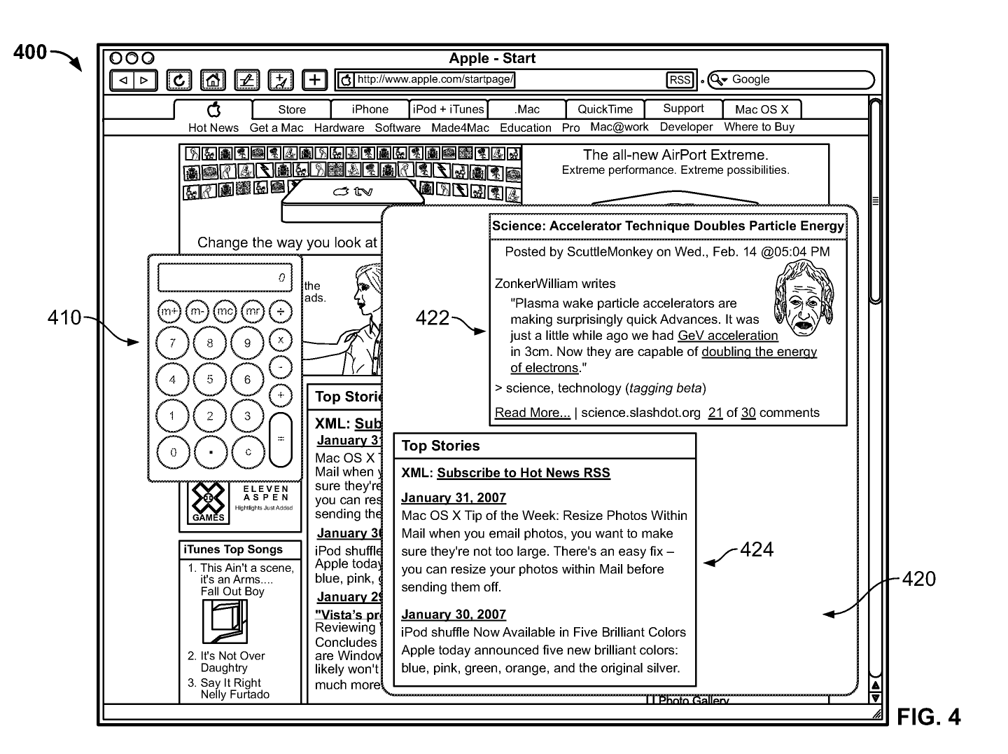

Described below are example instantiations of content, applications, and environments in which clippings can be created, presented or otherwise processed. Particular examples include a web instantiation in which web content can be displayed in a dashboard environment (described in association with FIG. 4). Other examples include “widget” (defined below) instantiation in a desktop display environment. Other instantiations are possible.

### Web Instantiation

A dashboard, or sometimes referred to as a “unified interest layer”, includes a number of user interface elements. The dashboard can be associated with a layer to be rendered and presented on a display. The layer can be overlaid (e.g., creating an overlay that is opaque or transparent) on another layer of the presentation provided by the presentation device (e.g. an overlay over the conventional desktop of the user interface). User interface elements can be rendered in the separate layer, and then the separate layer can be drawn on top of one or more other layers in the presentation device, so as to partially or completely obscure the other layers (e.g., the desktop). Alternatively, the dashboard can be part of or combined in a single presentation layer associated with a given presentation device.

One example of a user interface element is a widget. A widget generally includes software accessories for performing useful, commonly used functions. In general, widgets are user interfaces providing access to any of a large variety of items, such as, for example, applications, resources, commands, tools, folders, documents, and utilities. Examples of widgets include, without limitation, a calendar, a calculator, and address book, a package tracker, a weather module, a clipview (i.e., presentation of clipped content in a view) or the like. In some implementations, a widget may interact with remote sources of information (such as a webview discussed below), such sources (e.g., servers, where a widget acts as a client in a client-server computing environment) to provide information for manipulation or display. Users can interact with or configure widgets as desired. Widgets are discussed in greater detail in concurrently filed U.S. patent application entitled “Widget Authoring and Editing Environment.” Widgets, accordingly, are a container that can be used to present clippings, and as such, clipping application 100 can be configured to provide as an output a widget that includes clipped content and all its attending structures. In one implementation, clipping application 100 can include authoring tools for creating widgets, where such widgets are able to present clipped content.

In one particular implementation described in association with FIGS. 4-5, a clipping application allows a user to produce a clipping of web content. The clipping application receives an indication of one or more areas of interest from each of a plurality of web pages (e.g., by the selection of a plurality of web pages) containing content to be clipped, and allows a user to size (or resize) the areas of interest. The clips are then subsequently displayed in a window of a widget created by the clipping application, and both the widget and the clipping application are separate from the user's browser. The content from the areas of interest, including hyperlinks, radio buttons, and other interactive portions, are displayed in a window referred to as a webview, and are refreshed automatically, or otherwise by the clipping application or other refresh sources to provide the user with the latest or updated (or appropriate) content from the areas of interest.

FIG. 4 is a screenshot showing an example user interface with widgets and a clipview. The dashboard 400 includes widgets (e.g., calculator widget 410) and a clipview 420. Clipview 420 includes a first clipping 422 from a first content source (e.g., clipping 510 from FIG. 5B of content source 250), and a second clipping 424 from a second content source (e.g., clipping 500 from FIG. 5A of content source 200).

The clipping application 100 can store identifying information for the webview as a non-transitory file that the user can select and open. By storing the identifying information as a file, the clipping application enables the user to close the webview and later to reopen the webview without having to repeat the procedure for selecting the plurality of content sources, selecting content, sizing and positioning the webview, etc. The identifying information includes, for example, a uniform resource locator (“URL”) of the plurality of web pages, as well as additional information (e.g., a signature) that might be required to locate and access the content in the selected areas of interest. The identifying information also may include the latest (or some other version, such as the original clipping) content retrieved from the areas of interest. Thus, when the user reopens a webview, the clipping application may use the identifying information to display the latest contents as well as to refresh those contents.

### Presenting Clipped Content

As mentioned earlier, presentation engine 160 may present clipped content from a plurality of sources to a user according to the user's preferences. Presentation engine 160 and interactivity engine 150 may also allow the user to interact with the presentation of the clippings in a clipview. Such interactions may include, for example, allowing the user to reposition clippings in the clipview, resize clippings in the clipview, refreshing clippings in the clipview, remove clippings from the clipview, and add clippings to the clipview. For example, returning to FIG. 4, the user can interact with clipview 420 to reposition, resize, refresh, or remove clippings 422 and 424. Furthermore, the user can also add additional clippings from additional content sources to clipview 420 and interact with the presentation of these additional clippings in a similar manner.

While the above implementations have been described with respect to presenting clipped content from a plurality of content sources, it should be noted that these implementations also can be applied to various applications, such as, but not limited to, printing clipped content from a plurality of content sources or copying clipped content from a plurality of content sources.

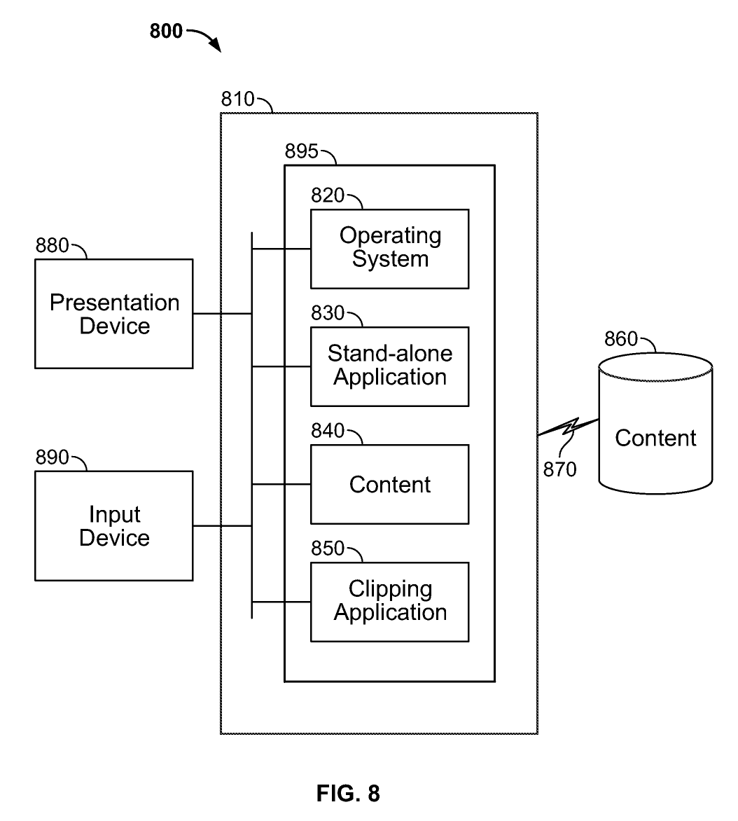

FIG. 8 is a block diagram showing a system for clipping content from a plurality of content sources. Referring to FIG. 8, a system 800 is shown for clipping content and presenting the clippings (or sometimes referred as, for example, a clipview or a webview) to a user. System 800 includes a processing device 810 having an operating system 820, a stand-alone application 830, a content source 840, and a clipping application 850. Each of elements 820-850 is communicatively coupled, either directly or indirectly, to each other. Elements 820-850 are stored on a memory structure 895, such as, for example, a hard drive. System 800 also includes a presentation device 880 and an input device 890, both of which are communicatively coupled to processing device 810. System 800 can further include content sources 860 that may be external to processing device 810, and communicatively coupled to processing device 810 over a connection 870.

Processing device 810 may include, for example, a computer, a gaming device, a messaging device, a cell phone, a personal/portable digital assistant (“PDA”), or an embedded device. Operating system 820 may include, for example, Mac OS X from Apple Inc. of Cupertino, Calif. Stand-alone application 830 may include, for example, a browser, a word processing application, a database application, an image processing application, a video processing application or other application. Content source 840 and content sources 860 may each include, for example, a document having any of a variety of formats, files, pages, media, or other content, and content sources 840 and 860 may be compatible with stand-alone application 830. Presentation device 880 may include, for example, a display, a computer monitor, a television screen, a speaker or other output device. Input device 890 may include, for example, a keyboard, a mouse, a microphone, a touch-screen, a remote control device, a speech activation device, or a speech recognition device or other input devices. Presentation device 880 or input device 890 may require drivers, and the drivers may be, for example, integral to operating system 820 or stand-alone drivers. Connection 870 may include, for example, a simple wired connection to a device such as an external hard disk, or a network, such as, for example, the Internet. Clipping application 850 as described in the preceding sections may be a stand-alone application as shown in system 800 or may be, for example, integrated in whole or part into operating system 820 or stand-alone application 830.

Processing device 810 may include, for example, a mainframe computer system, a personal computer, a personal digital assistant (“PDA”), a game device, a telephone, or a messaging device. The term “processing device” may also refer to a processor, such as, for example, a microprocessor, an integrated circuit, or a programmable logic device for implementing clipping application 100. Content sources 840 and 870 may represent, or include, a variety of non-volatile or volatile memory structures, such as, for example, a hard disk, a flash memory, a compact diskette, a random access memory, and a read-only memory.

Implementations may include one or more devices configured to perform one or more processes. A device may include, for example, discrete or integrated hardware, firmware, and software. Implementations also may be embodied in a device, such as, for example, a memory structure as described above, that includes one or more computer readable media having instructions for carrying out one or more processes. The computer readable media may include, for example, magnetic or optically-readable media, and formatted electromagnetic waves encoding or transmitting instructions. Instructions may be, for example, in hardware, firmware, software, or in an electromagnetic wave. A processing device may include a device configured to carry out a process, or a device including computer readable media having instructions for carrying out a process.

A number of implementations have been described. Nevertheless, it will be understood that various modifications may be made. For example, elements of one or more implementations may be combined, deleted, modified, or supplemented to form further implementations. Additionally, in further implementations, engines 110-160 need not perform all, or any, of the functionality attributed to that engine in the implementations described above, and all or part of the functionality attributed to one engine 110-160 may be performed by another engine, another additional module, or not performed at all. Though one implementation above describes the use of widgets to create webviews, other views can be created with and presented by widgets. Further, a single widget or single application can be used to create, control, and present clippings in accordance with the description above. Accordingly, other implementations are within the scope of the following claims.

What is claimed is:

1. A method, comprising:
receiving input to select a plurality of content sources and one or more portions of each of the plurality of content sources corresponding to areas of interest;
identifying a signature associated with each of the one or more portions;
storing the signatures; and
presenting clippings corresponding to the signatures in a clipview.

2. The method of claim 1, where presenting the clippings includes presenting the clippings at a same time.

3. The method of claim 1, where presenting the clippings includes presenting the clippings sequentially in time.

4. The method of claim 1, where presenting the clippings includes presenting the clippings according to user preferences.

5. The method of claim 1, where presenting the clippings includes presenting the clippings in a webview, wherein the webview is one form of a clipview.

6. The method of claim 1, further comprising receiving user input to toggle among a plurality of views.

7. A method, comprising:
providing a user interface for presentation on a display device, the user interface including a display area for displaying content;
identifying one or more portions of each of a plurality of content sources displayed in the display area, the portions corresponding to areas of interest;
identifying a signature associated with each of the one or more portions;
storing the signatures; and
presenting clippings corresponding to the signatures in a clipview in the user interface.

8. The method of claim 7, where presenting the clippings includes presenting the clippings at a same time.

9. The method of claim 7, where presenting the clippings includes presenting the clippings sequentially in time.

10. The method of claim 7, where presenting the clippings includes presenting the clippings according to user preferences.

11. The method of claim 7, where presenting the clippings includes presenting the clippings in a webview, wherein the webview is one form of a clipview.

12. The method of claim 7, further comprising receiving user input to toggle among a plurality of views.

13. A system comprising:
means for receiving input to select a plurality of content sources and one or more portions of each of the plurality of content sources corresponding to areas of interest;
means for identifying a signature associated with each of the one or more portions;
means for storing the signatures; and
means for presenting clippings corresponding to the signatures in a clipview.

14. The system of claim 13, where means for presenting the clippings includes means for presenting the clippings at a same time.

15. The system of claim 13, where means for presenting the clipping includes means for presenting the clippings sequentially in time.

16. The system of claim 13, where means for presenting the clippings includes means for presenting the clippings according to user preferences.

17. The system of claim 13, where means for presenting the clippings includes means for presenting the clippings in a webview, wherein the webview is one form of a clipview.

18. The system of claim 13, further comprising means for receiving user input to toggle among a plurality of views.

19. A computer program product, encoded on a computer-readable medium, operable to cause a data processing apparatus to:
receive input to select a plurality of content sources and one or more portions of each of the plurality of content sources corresponding to areas of interest;
identify a signature associated with each of the one or more portions;
store the signatures; and
present clippings corresponding to the signatures in a clipview.

20. A system comprising:
a processor;
a computer-readable medium coupled to the processor and having instructions contained thereon, which, when executed by the processor, causes the processor to perform the operations of:
receiving input to select a plurality of content sources and one or more portions of each of the plurality of content sources corresponding to areas of interest;
identifying a signature associated with each of the one or more portions;
storing the signatures; and
presenting clippings corresponding to the signatures in a clipview.

21. The system of claim 20, where presenting the clippings includes presenting the clippings at a same time.

22. The system of claim 20, where presenting the clipping includes presenting the clippings sequentially in time.

23. The system of claim 20, where presenting the clippings includes presenting the clippings according to user preferences.

24. The system of claim 20, where presenting the clippings includes presenting the clippings in a webview, wherein the webview is one form of a clipview.

25. The system of claim 20, further comprising instructions to perform the operations of:
receiving user input to toggle among a plurality of views.
